(19) United States
(12) Patent Application Publication
(10) Pub. No.: US 2008/0089067 A1
(43) Pub. Date: Apr. 17, 2008

(54) Light apparatus attachable to a tattoo machine

(76) Inventor: Scott Grosjean, San Bernadino, CA (US)

Correspondence Address: JAMES RAY & ASSOCIATES, 2640 PITCAIRN ROAD, MONROEVILLE, PA, 15146, US

(21) Appl. No.: 11/974,869

(22) Filed: Oct. 16, 2007

Related U.S. Application Data
(60) Provisional application No. 60/852,082, filed on Oct. 16, 2006.

(51) Int. Cl. F21V 19/02

(52) U.S. Cl. 362/285

(57) ABSTRACT

A light designed to be secured to and powered by a tattoo machine. Such light includes a first housing having a light source is disposed within. A second housing is connected to such first housing. A facilitating mechanism carries power to such light source. The facilitating mechanism is housed at a first end thereof within such second housing and at a second end thereof extends outside of such second housing. A first securing mechanism is connected to such second end of the facilitating mechanism for securing such second end to a power source of such tattoo machine. When the power source carries power to such tattoo machine power is carried by the facilitating mechanism to such light source and such light source is illuminated. A second securing mechanism is attached to at least one of such first housing and such second housing for securing the light to such tattoo machine.

### CROSS REFERENCE TO RELATED APPLICATION

This patent application is related to and claims priority from U.S. Provisional Patent Application Ser. No. 60/852,082 filed Oct. 16, 2006.

### FIELD OF THE INVENTION

The present invention relates, in general, to lights and, more particularly, this invention relates to a light for illuminating an area being tattooed.

### BACKGROUND OF THE INVENTION

Prior to the conception and development of the present invention, clip on lights or snake lights, as are generally well known in the prior art, have been used to illuminate books, car engines, and other work areas. However, there are no lights for attachment to a tattoo machine to illuminate the area being tattooed.

### SUMMARY OF THE INVENTION

The present invention provides a light specifically designed to be secured to and powered by a tattoo machine. There is a first housing having a first predetermined size and a first predetermined shape. A light source is removeably and operably connected to and disposed within such first housing. A second housing, having a second predetermined size and a second predetermined shape, is removably connected to such first housing.

A facilitating means for carrying power to the light source is removeably and operably connected at a first end thereof to the light source. The facilitating means is housed at such first end thereof within such second housing and a second end of such facilitating means extends outside of such second housing.

A first securing means is connected to the second end of such facilitating means for operably securing the second end of such facilitating means to a power source of such tattoo machine. When such power source is carrying power to such tattoo machine power is carried by such facilitating means to the light source. Upon receiving such power the light source is illuminated.

A second securing means is attached operably to at least one of such first housing and such second housing for securing the at least one of such first housing and such second housing to a predetermined portion of such tattoo machine.

### OBJECTS OF THE INVENTION

It is, therefore, one of the primary objects of the present invention to provide a light attachable to a tattoo machine specifically for directly lighting the area being tattooed.

Another object of the present invention is to provide a simple to use clip on light for attaching to a tattoo machine, such light being able to be easily adjusted so as to provide optimal light to an area being tattooed.

Still another object of the present invention is to provide a light attachment for a tattoo machine, that is powered by the tattoo machine's power source.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of a light specifically designed to be secured to and powered by a tattoo machine according to one embodiment of the invention.

FIG. 2 is a partial perspective view of a light specifically designed to be secured to and powered by a tattoo machine according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

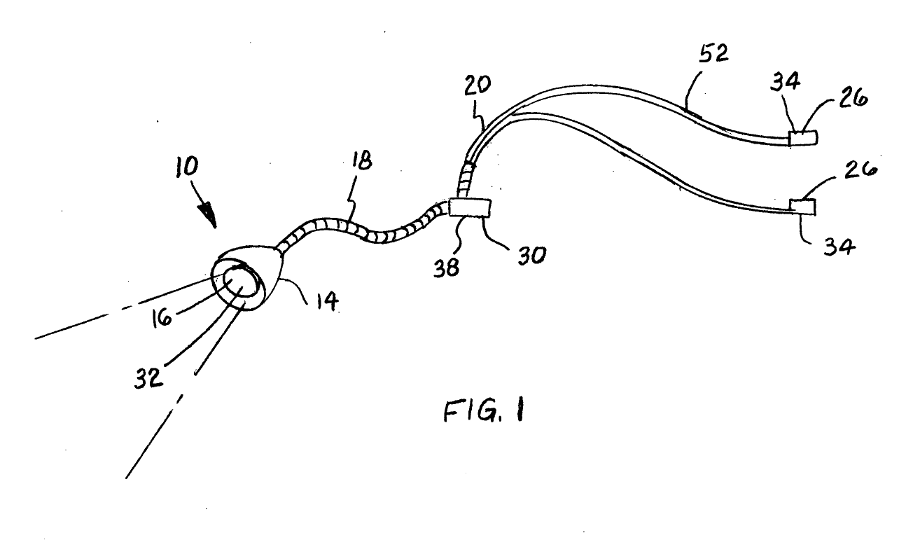

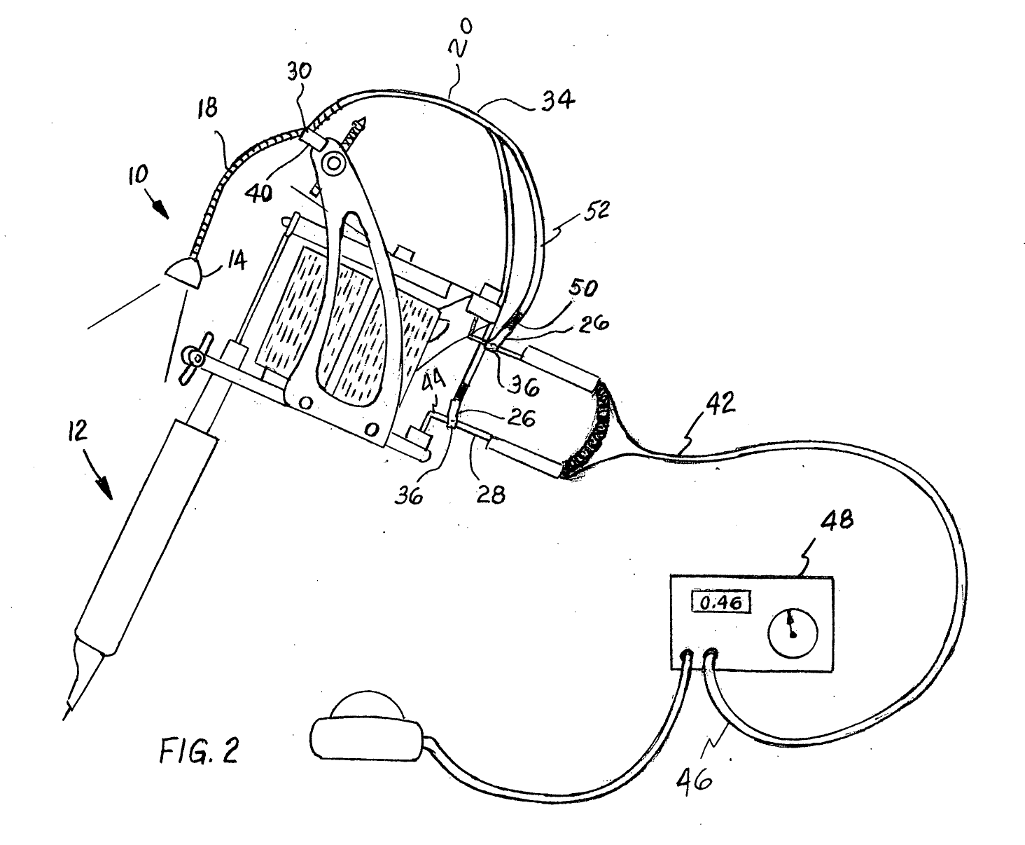

Reference is now made, more particularly, to FIGS. 1-2. According to a first embodiment of the invention, illustrated in FIGS. 1-2, a light, generally designated 10, specifically designed to be secured to and powered by a tattoo machine, generally designated 12, is provided.

Such light 10 includes a first housing 14 having a first predetermined size and a first predetermined shape. A light source 16 is removeably and operably connected to and disposed within such first housing 14.

A second housing 18, having a second predetermined size and a second predetermined shape, is removably connected to such first housing 14. It is presently preferred that such second housing 18 is between about 1½ and 2½ inches long. It is presently most preferred that such second housing 18 is 2 inches long.

A facilitating means, generally designated 20, for carrying power to such light source 16, is removeably and operably connected at a first end thereof to such light source 16. Such facilitating means 20 is housed at such first end thereof within such second housing 18 and a second end of such facilitating means 20 extends outside of such second housing 18.

At least one first securing means 26 is connected to such second end of such facilitating means 20 for operably securing such second end of such facilitating means 20 to a power source 28 of such tattoo machine 12. When such power source 28 is carrying power to such tattoo machine power is carried by such facilitating means 20 to such light source 16 such that upon receiving such power such light source 16 is illuminated.

A second securing means 30 is attached operably to at least one of such first housing 14 and such second housing 18 for securing such at least one of such first housing 14 and such second housing 18 to a predetermined portion of such tattoo machine 12.

It is presently preferred that such second housing 18 is at least one of bendable and adjustable such that such light source 16 can be oriented in a desired configuration for optimal lighting of one or more objects (not shown).

It is further presently preferred that such light source 16 is a light bulb 32 having a predetermined shape, size and wattage.

According to the presently preferred embodiment such at least one first securing means 26 is at least one of a spring loaded clamp 34 and a spring loaded clip 36. It is presently most preferred that such at least one spring loaded clamp 34 and at least one spring loaded clip 36 are manufactured from metal.

It is presently preferred that such second securing means 30 is at least one of at least one spring loaded clamp 38 and at least one spring loaded clip 40.

It is further presently preferred that such at least one first securing means 26 is connected to a clip cord 42 at a predetermined location thereof such clip cord being attached operably at a first end 44 thereof to such tattoo machine 12 and at a second end 46 thereof to such power supply 48 which when turned on supplies power to such tattoo machine 12.

In the presently preferred embodiment such second end of such facilitating means 20 consists of at least one metal wire 50 which is at least partially enclosed in an insulating material 52.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A light specifically designed to be secured to and powered by a tattoo machine, said light comprising:
(a) a first housing having a first predetermined size and a first predetermined shape;
(b) a light source removeably and operably connected to and disposed within said first housing;
(c) a second housing having a second predetermined size and a second predetermined shape, said second housing being removably connected to said first housing;
(d) a facilitating means for carrying power to said light source, said facilitating means being removeably and operably connected at a first end thereof to said light source, said facilitating means being housed at said first end thereof within said second housing and a second end of said facilitating means extending outside of said second housing;
(e) at least one first securing means is connected to said second end of said facilitating means for operably securing said second end of said facilitating means to a power source of such tattoo machine such that when such power source is carrying power to such tattoo machine power is carried by said facilitating means to said light source such that upon receiving such power said light source is illuminated, and
(f) a second securing means attached operably to at least one of said first housing and said second housing for securing said at least one of said first housing and said second housing to a predetermined portion of such tattoo machine.

2. A light apparatus, according to claim 1, wherein said second housing is at least one of bendable and adjustable such that said light source can be oriented in a desired configuration for optimal lighting of one or more objects.

3. A light apparatus, according to claim 1, wherein said light source is a light bulb having a predetermined shape, size and wattage.

4. A light apparatus, according to claim 1, wherein said at least one first securing means is at least one of a spring loaded clamp and a spring loaded clip.

5. A light apparatus, according to claim 1, wherein said second securing means is at least one of at least one spring loaded clamp and at least one spring loaded clip.

6. A light apparatus, according to claim 1, wherein said at least one first securing means is connected to a clip cord at a predetermined location thereof such clip cord being attached operably at a first end thereof to such tattoo machine and at a second end thereof to such power supply which when turned on supplies power to such tattoo machine.

7. A light apparatus, according to claim 1, wherein said second housing is between about 1½ and 2½ inches long.

8. A light apparatus, according to claim 1, wherein said second housing is 2 inches long.

9. A light apparatus, according to claim 1, wherein said second end of said facilitating means consists of at least one metal wire which is at least partially enclosed in an insulating material.

10. A light apparatus, according to claim 5, wherein said at least one first securing means is at least one of at least one metal spring loaded clamp and at least one metal spring loaded clip.
